(19) United States
(12) Patent Application Publication
(10) Pub. No.: US 2009/0243372 A1
(43) Pub. Date: Oct. 1, 2009

(54) HUB INSTALLED TO A BICYCLE

(76) Inventors: Tien-Wan HOU, Taipei (TW); Chia-Ling YANG, Taipei (TW)

Correspondence Address: Chien-Hui Su, P. O. Box 70-121 Taichung, Taichung City, 40899, TW

(21) Appl. No.: 12/056,280

(22) Filed: Mar. 27, 2008

(51) Int. Cl. B60B 27/00

(52) U.S. Cl. 301/110.5; 384/609

(57) ABSTRACT

A hub installed to a bicycle is disclosed. The normal force of each rolling ball set and the spindle has an inclined angle so that the bearing can suffer from a greater axial force so as to increase the lifetime of the hub. The sizes of the rolling balls are enlarged and the number of the rolling balls used is increased. The annular rib is integrally formed with the hub so as to increase the concentricity between the hub body and the ratchet wheel. The swing range of the hub is decreased and thus it is smooth. The first resisting portion, second resisting portion, seven resisting portion and eight resisting portion are matched to cambered recesses of the first rolling ball set, second rolling ball set, third rolling ball set, and fourth rolling ball set so that the resisting areas between the rolling balls and the resisting portions are increased.

### FIELD OF THE INVENTION

The present invention relates to hubs, in particular to a hub installed to a bicycle.

### BACKGROUND OF THE INVENTION

In 1970s, in U. S: bicycle motocross exercise becomes popular. The bicycle for this exercise is called as BMX bicycle which has a small size and wide tires. The exercise field for the bicycle is like that of the motorcycle. This exercise is widely accepted by young people. In 1980s, most young people are affected by scooters. They feel that it is dull as only compete in the exercise field. Thus, a young people, called BOBHARQ, adds four pedals at two sides of the rear wheel. The player can made more variations by these pedals. As result, the BMX runs on general ground, or scooter fields with more variations than those used in scooter. Thus BMX becomes BMX freestyle.

With reference to FIG. 1, a current used BMX freestyle bicycle 10 includes a bicycle frame 11, a rear wheel 14, a front wheel 14′ and a transfer system 15. The front wheel 14′ and the rear wheel 14 are assembled to a front supporting frame 12 and a rear supporting frame 13 of the bicycle frame 11. The transfer system 15 includes a pedal 16, a sprocket 17, a chain 18 and a hub 100. Treading the pedal 16 will drive the chain 17 to rotate and thus the chain 18 rotates. Then a hub body 120 will drive the rear wheel 14 to rotate so that the bicycle 10 runs. Besides, the pedal 19 and pedal 19′ are engaged to the rear wheel 14 and rear wheel 14′ so that the bicycle moves forwards and thus the bicycle may perform many different variations in driving.

FIG. 2 shows a hub of a BMX freestyle bicycle. The hub 100 is formed by a spindle 110, a hub body 120, a ratchet wheel 130, and a plurality of bearings 140. The hub body 120 and the ratchet wheel 130 are engaged to the spindle 110. The hub body 120 and the ratchet wheel 130 are rollably connected the spindle 110 by using the bearings 140. The bearing 140 in FIG. 2 is a deep-groove ball bearing which can well suffer the radial pressure, but it cannot well release axial pressure so that the bearings 140 are easy to destroy. As a result, the bearings 140 are necessary to be updated, while this increases the cost. Therefore, a novel hub which can suffer from axial pressures is necessary for increasing the lifetime of the hub.

### SUMMARY OF THE INVENTION

Accordingly, the primary object of the present invention is to provide a hub installed to a bicycle, which can suffer from a greater axial stress and thus the lifetime of the hub is prolonged. The cost is low and the strength of the whole hub is increased.

To achieve above objects, the present invention provides a hub installed to a bicycle, comprising: a spindle having an annular rib which is integrally formed to the spindle; and the annular rib having a first resisting portion and a second resisting portion; a hub body installed to the spindle; an interior of the hub body having a third resisting portion and a fourth resisting portion; a ratchet wheel installed to the spindle; an interior of the ratchet wheel having a fifth resisting portion and a sixth resisting portion; a first rolling ball set formed by a plurality of first rolling balls which is installed between the first resisting portion and the fourth resisting portion; and a normal force from the first resisting portion to the first rolling balls and the spindle is formed as a first inclined angle; a second rolling ball set formed by a plurality of second rolling balls; the second rolling ball set being installed between the second resisting portion and the fifth resisting portion; and a normal force from the second resisting portion to the second rolling balls and the spindle is formed with a second inclined angle; a first tapered body engaged to one end of the spindle; and an outer side of the first tapered body having a seven resisting portion; a second tapered body engaged to another end of the spindle, an outer side of the second tapered body having an eight resisting portion; a third rolling ball set being formed by a plurality of third rolling balls; the second rolling ball set being installed between the sixth resisting portion and the seven resisting portion; and a normal force from the seven resisting portion to the third rolling balls and the spindle is formed with a third inclined angle; and a fourth rolling ball set formed by a plurality of fourth rolling balls; the fourth rolling balls being installed between the third resisting portion and the eight resisting portion; and a normal force from the eight resisting portion to the fourth rolling balls and the spindle is formed as a fourth inclined angle.

The first rolling ball set, the second rolling ball set, the third rolling ball set, and the fourth rolling ball set are formed by grinding

The first, second, third and fourth inclined angles are between 60 degrees to 65 degrees.

The present invention further comprises a first bowl; and an outer side of the first bowl resists against the first resisting portion; and an inner side of the first bowl resists against the first rolling ball set.

The first bowl is made of steel; and the hub body is made of aluminum.

The present invention further comprises a second bowl; and an outer side of the second bowl resists against the third resisting portion; and an inner side of the second bowl resists against the fourth rolling ball set.

The second bowl is made of steel; and the hub body is made of aluminum.

The first resisting portion is a cambered recess matched to the first rolling ball set; the second resisting portion is a cambered recess matched to the second rolling ball set; the eight resisting portion is a cambered recess matched to the third rolling ball set; and the eight resisting portion is a cambered recess matched to the first rolling ball set.

The normal force of each rolling ball set and the spindle has an inclined angle so that the bearing can suffer from a greater axial force so as to increase the lifetime of the hub. Therefore, no bearing is used in the hub of the present invention and thus the cost is lowered so that the cost is low. The sizes of the rolling balls are enlarged and the number of the rolling balls used is increased so that the whole strength of the whole hub is enhanced. Besides, the annular rib is integrally formed with the hub so as to increase the concentricity between the hub body and the ratchet wheel. The swing range of the hub is decreased and thus it is smooth. Besides, the first resisting portion, second resisting portion, seven resisting portion and eight resisting portion are matched to cambered recesses of the first rolling ball set, second rolling ball set, third rolling ball set, and fourth rolling ball set so that the resisting areas between the rolling balls and the resisting portions are increased. The lifetimes of the rolling balls are increased.

The various objects and advantages of the present invention will be more readily understood from the following detailed description when read in conjunction with the appended drawing.

### BRIEF DESCRIPTION OF THE DRAWINGS

FIG. 1 is a BMX bicycle of the prior art.

FIG. 2 is a hub used to the BMX bicycle.

FIG. 3 is a cross sectional view of the hub of the present invention.

FIG. 4 is an exploded view showing the parts of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

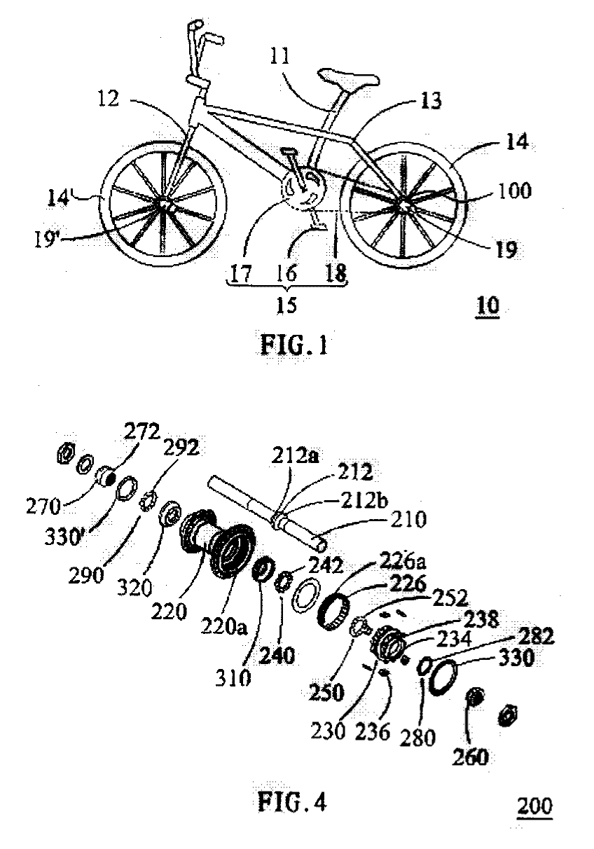

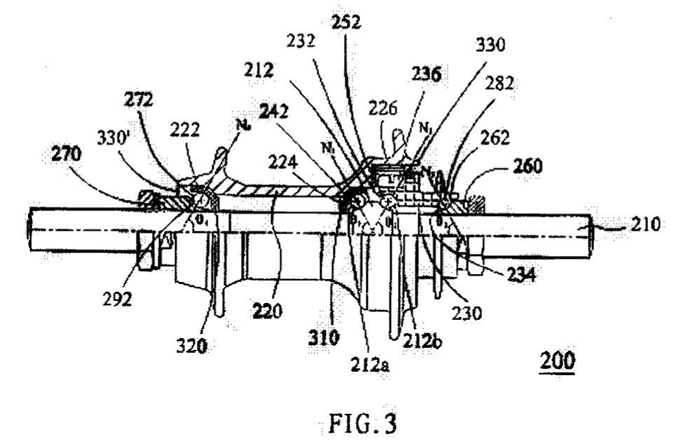

Referring to FIG. 3, a cross sectional view about the hub of the present invention is illustrated in and FIG. 4 is an exploded perspective view of the hub is illustrated. The hub 200 includes a spindle 210, a hub body 220, a first rolling ball set 240, a second rolling ball set 250, a first tapered body 260, a second tapered body 270, a third rolling ball set 280, and a fourth rolling ball set 290. The spindle 210 is installed with an annular rib 212 which is integrally formed on the spindle 210. The annular rib 212 is formed with two recesses, which are a first resisting portion 212a and a second resisting portion 212b. The first resisting portion 212a is a cambered recess matched to the first rolling ball set 240 and the second resisting portion 212b is a cambered recess matched to the second rolling ball set 250. The hub body 220 is engaged to the spindle 210. An interior of the hub body 220 has a recessed third resisting portion 222 and a recessed fourth resisting portion 224. The ratchet wheel 230 is engaged to the spindle 210. An interior of the ratchet wheel 230 has a recessed fifth resisting portion 232 and a recessed sixth resisting portion 234. A sprocket 238 is installed upon the ratchet wheel 230. A chain can be engaged upon the sprocket 238 (as the chain 18 in FIG. 1). It is possible that a plurality of sprockets are engaged to the ratchet wheel 230 so as to have the function of speed change.

The first rolling ball set 240 is formed by a plurality of first rolling balls 242. The first rolling ball set 240 is installed between the first resisting portion 212a and the fourth resisting portion 224. The force applied line of the normal force N1 from the first resisting portion 212a to the first rolling balls 242 and the axial line of the spindle 210 is formed with an angle of θ1 which is preferably between 60 degrees to 65 degrees. Besides, the second rolling ball set 250 is mainly formed by a plurality of second rolling balls 252. The second rolling ball set 250 is installed between the second resisting portion 212b and the fifth resisting portion 232. An angle θ2 is formed between the force applied line of the normal force N2 from the second resisting portion 212b to the fifth rolling balls 232 and the axial line of the spindle 210. Preferably the angle θ2 is between 60 degrees to 65 degrees.

Furthermore, the first tapered body 260 is engaged to one end of the spindle 210. An outer portion of the first tapered body 260 has a recessed seven resisting portion 262 which is shaped to match the cambered recess of the third rolling ball set 280. The second tapered body 270 is engaged to another end of the spindle 210. An outer side of the second tapered body 270 has a recessed eight resisting portion 272 which is a cambered recess matched to the fourth rolling ball set 290. The third rolling ball set 280 is formed by a plurality of third rolling balls 282 which is installed between the sixth resisting portion 234 and the seven resisting portion 262. The force applied line of the normal force N3 from the seven resisting portion 262 to the third rolling balls 282 and the axial direction of the spindle 210 is formed with an angle of θ3 which is preferably between 60 degrees to 65 degrees. Besides, the fourth rolling ball set 290 is mainly formed by a plurality of fourth rolling balls 292. The fourth rolling ball set 290 is installed between the third resisting portion 222 and the eighth resisting portion 272. The force applied line of the normal force N4 from the eighth resisting portion 272 to the fourth rolling balls 292 and the axial line of the spindle 210 is formed with an angle of θ4 which is preferably between 60 degrees to 65 degrees.

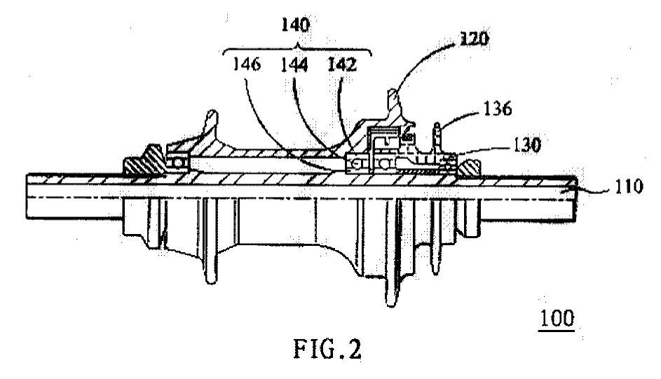

The normal forces N1 to N4 from the first rolling balls 242 to fourth rolling balls 292 are inclined to the spindle 210. The hub 200 of the present invention is more flexible for suffering from the axial pressure of the prior art hub 100 (as shown in FIG. 2). Therefore, comparing with the prior art hub 100, the hub 200 of the present invention has a longer lifetime.

Moreover, in the prior art, the hub body 120 and the ratchet wheel 130 are rollably connected by the bearing 140 and the spindle 110. The bearing 140 is mainly formed by an outer layer 142, an inner layer 146 and a plurality of rolling balls 144, but in the present invention, the hub body 220 and the ratchet wheel 230 are rollable connected to the spindle 210 by using the first rolling ball set 240, second rolling ball set 250, third rolling ball set 280 and fourth rolling ball set 290. With reference to FIGS. 2 and 3, in this embodiment, as comparing with the prior art hub 100, the hub 200 of the present invention has no the outer layer 142 and the inner layer 146 and thus the cost is lowered.

Moreover, because the hub 200 has no outer layer 142 and inner layer 146, the sizes of the rolling balls can be enlarged and the number of the rolling balls can be increased. For example, in the second rolling ball set 250, the number of the second rolling balls 252 is 13a and the diameter of the second rolling balls 252 is 4.6 mm, while in the prior art hub 100, the number of the rolling balls 10 with respect to the prior art bearing 140 The diameter of the rolling balls is 4.0 mm. Since the hub 200 of the present invention has more rolling balls and size of the rolling ball is bigger, the strength of the hub 200 is enhanced.

Furthermore, the annular rib 212 is integrally formed in the spindle 210. This can increase the concentricity of the hub body 220 and the ratchet wheel 230. If the annular rib 212 is locked to the spindle 210, a clearance between the annular rib 212 and the spindle 210 is generated so that the concentricity between the annular rib 212 and the spindle 210 is not preferred. However, in this embodiment, the annular rib 212 is integrally formed to the spindle 210, no clearance generates between the annular rib 212 and the spindle 210. Thus the concentricity between the annular rib 212 and the spindle 210 is increased so as to reduce the swinging range of the hub 200. Thus, the structure is smooth. Moreover, preferably, the first rolling balls 242, second rolling balls 252, third rolling balls 272 and fourth rolling balls 282 are formed by grindings so that the hub 200 is smooth.

In the hub 200, the hub body 220 is a largest element. For reducing the weight of the whole structure, generally, the hub body 220 is made of aluminum. However since the material of the first rolling balls 242 is steel. If the first rolling balls 242 are directly in contact with the hub body 220, when the first rolling balls 242 rolls, the hub body 220 is easy to wear and thus deform. Therefore, preferably, the hub body 220 is installed with a first bowl 310. An outer side of the first bowl 310 resists against the fourth resisting portion 224 and an inner side of the first bowl 310 resists against the first rolling ball set 240. Therefore, when the first rolling ball set 240 rolls, the hub body 220 is difficult to wear and deform. Besides, preferably, the hub body 220 is installed with a second bowl 320, an outer side of the second bowl 320 resists against the first resisting portion 212a and an inner side of the second bowl 320 resists against the fourth rolling ball set 290. The function of the second bowl 320 is like that of the second bowl 320. Thus the detail will not further described herein.

The ratchet wheel 230 is installed with a plurality of claws 236 for example, which is spaced-equally arranged around the ratchet wheel 230. Besides, an interior of the hub body 220 is installed with an inner teethed ring 226 which is locked to the threads 221 of the hub body 220 by outer thread 226a of the inner teethed ring 226 so as to be fixed to the interior of the hub body 220. Referring to FIG. 4, when the ratchet wheel 230 rotates clockwise, the claws 226a will engage to the inner teeth of the inner teethed ring 226. When the inner teethed ring 226 rotates, the hub body 220 will rotate therewith. When the inner teethed ring 226 rotates counterclockwise, the claws 236 will slide through the inner teeth of the inner teethed ring 226 so that the ratchet wheel 230 rotate idly.

Moreover, the hub 200 has a dust-proof ring 330 and a dust-proof ring 330′. The dust-proof ring 330 is installed to be between the hub body 220 and the ratchet wheel 230 for sealing the clearance between the hub body 220 and the ratchet wheel 230. The dust-proof ring 330′ is installed between the hub body 220 and the second tapered body 270 for sealing the clearance between the hub body 220 and the second tapered body 270. The dust-proof ring 330 and dust-proof ring 330′ serve to prevent dust from flowing into the hub 200.

In summary, in the hub of the present invention, the normal forces to the rolling balls is inclined to the spindle, and thus it can suffer from a greater axial pressure than the prior art structures. No bearing is used in the hub of the present invention, the cost is low and the sizes of the rolling balls can be increased. And more rolling balls can be used so as to enhance the whole strength of the hub Furthermore, the annular rib is integrally formed with the spindle, the concentricity between the hub body and the ratchet wheel is enhanced so that the swing range of the hub is decreased and it is more smooth. Furthermore, the first resisting portion, second resisting portion, seven resisting portion and eight resisting portion are matched to cambered recesses of the first rolling ball set, second rolling ball set, third rolling ball set and fourth rolling ball set so that the contact areas between the rolling balls and the resisting portions are increased. Therefore, the lifetime of the rolling balls is prolonged.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hub installed to a bicycle, comprising:
a spindle having an annular rib which is integrally formed to the spindle; and the annular rib having a first resisting portion and a second resisting portion;
a hub body installed to the spindle; an interior of the hub body having a third resisting portion and a fourth resisting portion;
a ratchet wheel installed to the spindle; an interior of the ratchet wheel having a fifth resisting portion and a sixth resisting portion;
a first rolling ball set formed by a plurality of first rolling balls which are installed between the first resisting portion and the fourth resisting portion; and a force applied line of a normal force from the first resisting portion to the first rolling balls and an axial direction of the spindle is formed as a first inclined angle;
a second rolling ball set formed by a plurality of second rolling balls; the second rolling ball set being installed between the second resisting portion and the fifth resisting portion; and a force applied line of a normal force from the second resisting portion to the second rolling balls and an axial direction of the spindle is formed with a second inclined angle;
a first tapered body engaged to one end of the spindle; and an outer side of the first tapered body having a seven resisting portion;
a second tapered body engaged to another end of the spindle; an outer side of the second tapered body having an eight resisting portion;
a third rolling ball set being formed by a plurality of third rolling balls; the third rolling ball set being installed between the sixth resisting portion and the seven resisting portion; and a force applied line of a normal force from the seven resisting portion to the third rolling balls and an axial direction of the spindle is formed with a third inclined angle; and
a fourth rolling ball set formed by a plurality of fourth rolling balls; the fourth rolling balls being installed between the third resisting portion and the eight resisting portion; and a force applied line of a normal force from the eight resisting portion to the fourth rolling balls and an axial direction of the spindle is formed as a fourth inclined angle.

2. The hub installed to a bicycle as claimed in claim 1, wherein the first rolling balls, the second rolling balls, the third rolling balls, and the fourth rolling balls are formed by grinding.

3. The hub installed to a bicycle as claimed in claim 1, wherein the first inclined angle is between 60 degrees to 65 degrees.

4. The hub installed to a bicycle as claimed in claim 1, wherein the second inclined angle is between 60 degrees to 65 degrees.

5. The hub installed to a bicycle as claimed in claim 1, wherein the third inclined angle is between 60 degrees to 65 degrees.

6. The hub installed to a bicycle as claimed in claim 1, wherein the fourth inclined angle is between 60 degrees to 65 degrees.

7. The hub installed to a bicycle as claimed in claim 1, further comprising: a first bowl; and an outer side of the first bowl resists against the first resisting portion; and an inner side of the first bowl resists against the first rolling ball set.

8. The hub installed to a bicycle as claimed in claim 7, wherein the first bowl is made of steel; and the hub body is made of aluminum.

9. The hub installed to a bicycle as claimed in claim 1, further comprising: a second bowl; and an outer side of the second bowl resists against the third resisting portion; and an inner side of the second bowl resists against the fourth rolling ball set.

10. The hub installed to a bicycle as claimed in claim 7, wherein the second bowl is made of steel; and the hub body is made of aluminum.

11. The hub installed to a bicycle as claimed in claim 1, wherein the first resisting portion is a cambered recess matched to the first rolling ball set; the second resisting portion is a cambered recess matched to the second rolling ball set; the seven resisting portion is a cambered recess matched to the third rolling ball set; and the eight resisting portion is a cambered recess matched to the fourth rolling ball set.
